(19) United States
(12) Patent Application Publication
(10) Pub. No.: US 2006/0038439 A1
(43) Pub. Date: Feb. 23, 2006

(54) Structure of an ornamental cover of a wheel cover

(76) Inventor: Hung-Sheng Wang, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/919,245

(22) Filed: Aug. 17, 2004

(51) Int. Cl. B60B 7/00

(52) U.S. Cl. 301/37.105

(57) ABSTRACT

An ornamental cover includes a main body, and an ornamental counterweight; the main body is fitted on a wheel cover of a car, and it is formed with fitting holes; the counterweight has fitting projections on a rear side thereof, and it is detachably fitted on an outward side of the main body with the fitting projections being respectively fitted in the fitting holes; after the counterweight is removed from the main body, the main body will turn together with the wheel cover while the car is moving; the counterweight has such a weight that after it is secured on the main body, the main body will stay in an upright position.

### BACKGROUND OF THE INVENTION

1. Field of the invention

The present invention relates to an ornamental cover of a wheel cover, more particularly, which includes a main body fitted on a wheel cover, and an ornamental counterweight detachably fitted on the main body for preventing the main body from turning together with the wheel cover.

2. Brief Description of the Prior Art

Ornamental covers are available that can be fitted on outward sides of wheel covers; the ornamental covers are made to present images, and they have counterweights secured thereto, and the wheel covers can turn relative to them such that the ornamental covers will stay in the upright position when the wheel covers are turning. Therefore, the ornamental covers can help improve the look of the wheel covers.

However, because the counterweights, which are secured on the above ornamental covers, can't be removed, it is impossible for the ornamental covers to be adjusted as to turn together with the wheel covers even if the users want them to. Therefore, ornamental covers of such structure are not flexible, incapable of meeting the users' need for change. Furthermore, most conventional ornamental covers are usually not formed with counterweights having such appearance as to match the main bodies of the ornamental covers.

### SUMMARY

It is an object of the invention to provide an improvement on an ornamental cover of a wheel cover to overcome the above disadvantage.

The ornamental cover of the present invention includes a main body, and an ornamental counterweight. The main body is fitted on a wheel cover of a car, and it is formed with fitting holes. The counterweight has fitting projections on a rear side thereof, and it is detachably fitted on an outward side of the main body with the fitting projections being respectively fitted in the fitting holes. After the counterweight is removed from the main body, the main body will turn together with the wheel cover while the car is moving. And, the counterweight has such a weight that after it is secured on the main body, the main body will stay in the upright position, even if the car is moving.

### BRIEF DESCRIPTION OF THE DRAWINGS

The present invention will be better understood by referring to the accompanying drawings, wherein:

FIG. 1 is an exploded perspective view of the present invention,

FIG. 2 is a front view of the present invention, with the ornamental counterweight being detached,

FIG. 3 is a front view of the present invention, and

FIG. 4 is a horizontal section of the present invention.

### DETAILED DESCRIPTION OF THE PREFERRED EMBODIMENTS

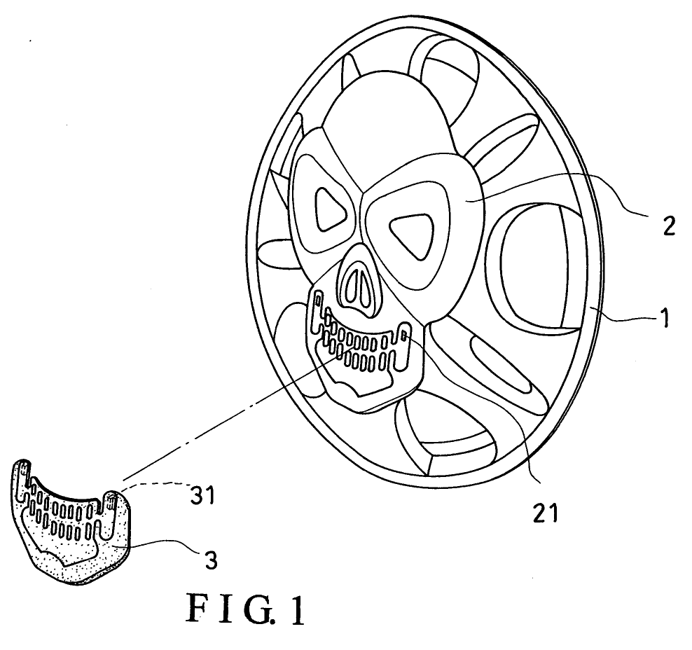

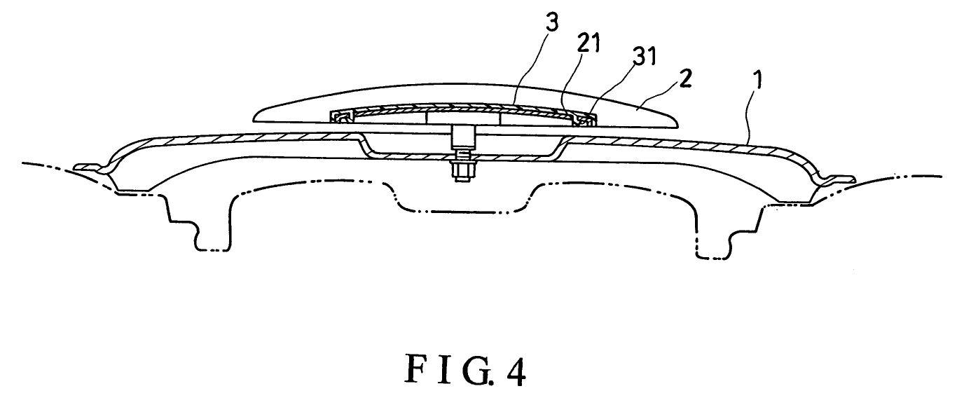

Referring to FIGS. 1 to 4, a preferred embodiment of an ornamental cover of a wheel cover includes a main body 2, and an ornamental counterweight 3.

The main body 2 of the ornamental cover is made to present an image, and it is fitted on and angularly displaceable relative to a wheel cover 1 of a car. Furthermore, the main body 2 is formed with two fitting holes 21 on a lower portion thereof.

The ornamental counterweight 3 is formed with two fitting projections 31 on a rear side thereof, and it can be secured on the lower portion of the main body 2 with the fitting projections 31 being respectively fitted in the fitting holes 21 of the main body 2, and with an edge thereof being closely around an edge of the lower portion of the main body 2. The ornamental counterweight 3 has such a weight that after it is secured on the main body 2, the main body 2 will stay in the upright position even if the car is moving. The ornamental counterweight 3 is formed with such a look as to match the main body 2, and it is made to be such colors as to meet the consumers' demand. In addition, the ornamental counterweight 3 is preferably made to be fluorescent colors such that it can be easily seen. The ornamental counterweight 3 can also be equipped with light emitting elements thereon such that light will be emitted from it when the light emitting elements are activated.

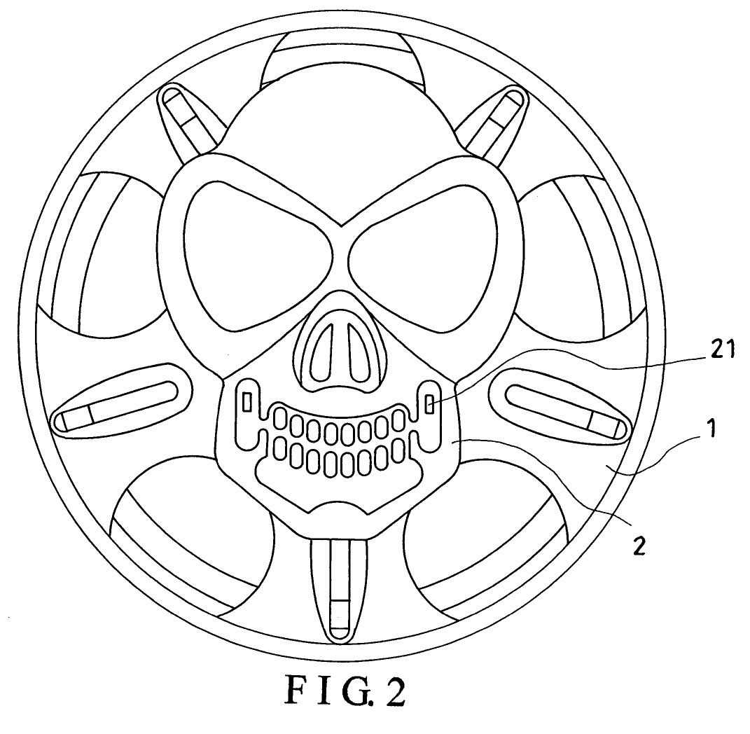

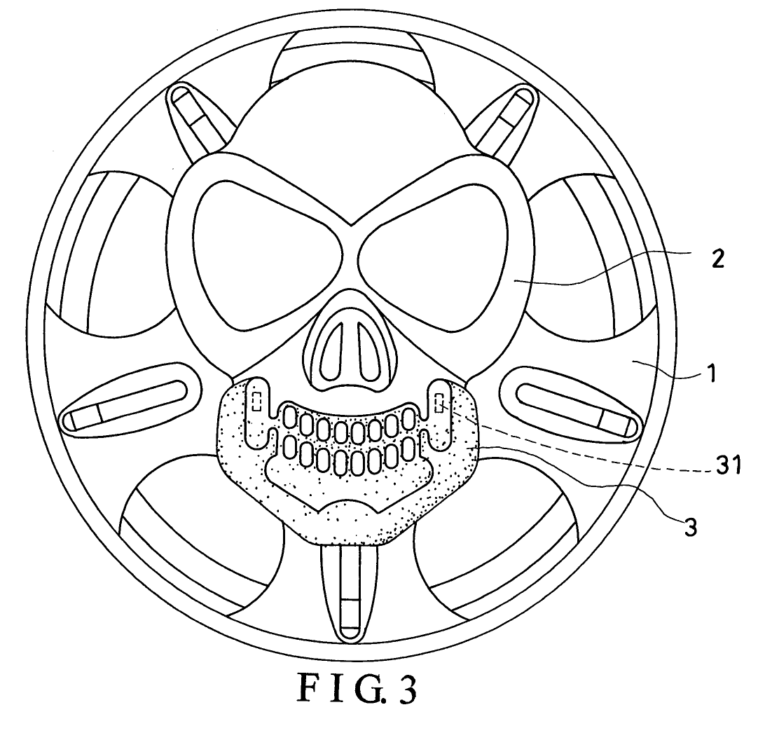

Therefore, the main body 2 of the ornamental cover will turn together with the wheel when the car is moving after the ornamental counterweight 3 is removed from the main body 2 as shown in FIG. 2. And, after the ornamental counterweight 3 is fitted on the main body 2 as shown in FIG. 3, the main body 2 will stay in the upright position, even if the car is moving.

From the above description, it can be easily understood that the present ornamental cover of a wheel cover has the following advantages:
1. Because the ornamental counterweight 3 can match the main body 2, the main body 2 will be even more attractive after the ornamental counterweight 3 is fitted on the main body 2. And, the ornamental counterweight 3 will make the main body 2 stay in the upright position, even if the car is moving. The ornamental counterweight 3 is convenient to use, because it is connected with the main body 2 simply by means of inserting the fitting projections 31 thereof into the fitting holes 21.
2. After the ornamental counterweight 3 is removed from the main body 2, the main body 2 will turn together with the wheel when the car is moving. And, the ornamental counterweight 3 can be easily removed from the main body 2 by means of separating the fitting projections 31 thereof from the fitting holes 21.

What is claimed is:

1. An ornamental cover of a wheel cover, comprising
a main body fitted on and angularly displaceable relative to a wheel cover of a car; the main body being formed with a plurality of fitting holes; and
an ornamental counterweight having a plurality of fitting projections on a rear side thereof; the ornamental counterweight being detachably fitted on an outward side of the main body with the fitting projections being respectively fitted in the fitting holes of the main body;
the main body being going to turn together with the wheel cover while the car is moving after the counterweight is removed from the main body; the ornamental counterweight having such a weight that after it is secured on the main body, the main body will stay in an upright position.

2. The ornamental cover of a wheel cover as claimed in claim 1, wherein the ornamental counterweight will be closely around an edge of a lower portion of the main body at an edge thereof when it is secured on the main body, and it is formed with such a look as to match the main body.

3. The ornamental cover of a wheel cover as claimed in claim 1, wherein the ornamental counterweight is colored.

4. The ornamental cover of a wheel cover as claimed in claim 1, wherein the ornamental counterweight is made to be fluorescent colors.

5. The ornamental cover of a wheel cover as claimed in claim 1, wherein the ornamental counterweight are equipped with a plurality of light emitting elements such that light will be emitted from it when the light emitting elements are activated.
